(19) United States
(12) Patent Application Publication
(10) Pub. No.: US 2016/0321504 A1
(43) Pub. Date: Nov. 3, 2016

(54) System Including An Optical Head-Mounted Display Useful During Manufacturing of a Medical Device

(71) Applicant: Boston Scientific Neuromodulation Corporation, Valencia, CA (US)

(72) Inventor: Goran N. Marnfeldt, Valencia, CA (US)

(21) Appl. No.: 15/046,574

(22) Filed: Feb. 18, 2016

Related U.S. Application Data
(60) Provisional application No. 62/154,553, filed on Apr. 29, 2015.

(51) Int. Cl. G06K 9/00; H04N 7/18; G06T 7/00

(52) U.S. Cl. CPC G06K 9/00671; G06T 7/0006; H04N 7/185; G06T 2200/24; G06T 2207/30164; G06T 2207/30204

(57) ABSTRACT

An Optical Head-Mounted Display (OHMD) wearable by an assembly technician and a system in which such OHMD may be used are disclosed. The OHMD is useable to optically verify parts used during an assembly stage of a subassembly of an Implantable Medical Device (IMD) for example, such as to verify that the correct parts are being used, and are properly placed within the subassembly. The OHMD further renders an OHMD Graphical User Interface to assist the technician in following the correct assembly steps, and to provide the technician feedback regarding optical verification and corrective actions that can be taken. Optical verification of parts and of the subassembly itself can occur using various optical markers on the parts and subassembly, such as bar codes, shapes, and text. The OHMD preferably also stores information relevant to such optical verification in a specific device log for the IMD for future reference.

### CROSS REFERENCE TO RELATED APPLICATIONS

This is a non-provisional application of U.S. Provisional Patent Application Ser. No. 62/154,553, filed Apr. 29, 2015, to which priority is claimed, and which is incorporated by reference in its entirety.

### FIELD OF THE INVENTION

The present invention relates generally to implantable medical devices, and more particularly to systems and methods for manufacturing implantable medical devices or other devices.

### BACKGROUND

Implantable stimulation devices deliver electrical stimuli to nerves and tissues for the therapy of various biological disorders, such as pacemakers to treat cardiac arrhythmia, defibrillators to treat cardiac fibrillation, cochlear stimulators to treat deafness, retinal stimulators to treat blindness, muscle stimulators to produce coordinated limb movement, spinal cord stimulators to treat chronic pain, cortical and Deep Brain Stimulators (DBS) to treat motor and psychological disorders, and other neural stimulators to treat urinary incontinence, sleep apnea, shoulder subluxation, etc. The description that follows will generally focus on the use of the invention within a Spinal Cord Stimulation (SCS) system, such as that disclosed in U.S. Pat. No. 6,516,227. However, the present invention may find applicability with any Implantable Medical Device (IMD) or in any IMD system.

As shown in FIGS. 1A and 1B, a SCS system includes an Implantable Pulse Generator (IPG) 10 (hereinafter, and more generically, IMD 10), which includes a biocompatible device case 12 formed of titanium for example. The case 12 typically holds the circuitry and battery 26 necessary for the IMD 10 to function, and is typically formed of top 13 and bottom 14 case portions welded together during the IMD 10's manufacture. The IMD 10 is coupled to electrodes 16 via one or more electrode leads 18 (two of which are shown). The proximal ends of the leads 18 are coupled to the IMD 10 at one or more lead connectors 20 fixed in a header 22, which can comprise an epoxy for example. In the illustrated embodiment, there are sixteen electrodes, although the number of leads and electrodes is application specific and therefore can vary. In an SCS application, two electrode leads 18 are typically implanted on the right and left side of the dura within the patient's spinal column. The proximal ends of the leads 18 are then tunneled through the patient's flesh to a distant location, such as the buttocks, where the IMD case 12 is implanted, at which point they are coupled to the lead connectors 20.

As shown in FIG. 1B, IMD 10 contains a charging coil 24 for wirelessly charging the IMD's battery 26 using an external charging device (not shown). (If battery 14 is not rechargeable, charging coil 26 can be dispensed with), and a telemetry coil antenna 28 for wirelessly communicating data with an external controller device (not shown). In other examples, antenna 28 can comprise a short-range RF antenna such as a slot, patch, or wire antenna. IMD 10 also contains control circuitry such as a microcontroller 30, and one or more Application Specific Integrated Circuit (ASICs) 32. ASIC(s) 32 can be as described for example in U.S. Pat. No. 8,768,453 and can contain circuitry modules for enabling various functions in the IMD 10. For example, ASIC(s) 32 can include stimulation circuitry for providing pulses of a prescribed current amplitude, duration, frequency, and polarity at one or more of the electrodes 16; telemetry modulation and demodulation circuitry for enabling bidirectional wireless communications at antenna 28; battery charging and protection circuitry coupleable to charging coil 24, etc. Components within the case 12 electrically coupled to a printed circuit board (PCB) 34.

FIG. 2 shows a plan view of IMD 10 at one stage of its manufacture. At this stage, the PCB 34 has been placed in the bottom portion 14 of the case 12, and certain parts have been added to the PCB 34. Various parts introduced earlier are shown from this top view of the PCB 34, including the battery 26, the telemetry antenna 28, the microcontroller 30, and the ASIC 32 (only one of which is shown). Other aspects are also shown, such as contact holes 37 which later in manufacturing will accommodate feedthrough pins 36 (FIG. 1B) that pass through the case 12 to the lead connectors 20. Other random components 40 and 42 are shown on the top of the PCB 38, as are a number of smaller Parts 44. Parts 44 may for example comprise DC-blocking capacitors, which are used in series in the current output paths to each of the electrodes 16 to prevent DC current injection into the tissue of the patient. See, e.g., U.S. Patent Application Publication 2015/0157861.

Manufacture of the IMD 10 may be automated at various stages, and may involve the use of automated fabrication equipment. But certain manufacturing stages may also involve human assembly technicians, who despite diligence and thorough training are prone to error. The inventor has devised a system to assist such technicians in their task, and to record important IMD assembly details.

### BRIEF DESCRIPTION OF THE DRAWINGS

FIGS. 1A and 1B show an Implantable Medical Device (IMD) in plan and cross-sectional views, in accordance with the prior art.

FIGS. 2 shows the IMD at a stage in manufacture, in accordance with the prior art.

FIG. 3A shows an Optical Head-Mounted Display (OHMD) wearable by an IMD assembly technician, and FIG. 3B shows a typical assembly environment in which the OHMD can be used during a particular assembly stage to create an IMD subassembly, in accordance with examples of the invention.

FIG. 4A shows parts in an IMD subassembly with various optimal markers used for optical verification by the OHMD, and FIG. 4B illustrates various optical attributes of the parts and their optical markers, in accordance with examples of the invention.

FIGS. 5A and 5B show an assembly file for a particular type of IMD being assembled, including various optical attributes of its parts, and stage algorithms used by the OHMD during various assembly stages, in accordance with examples of the invention.

FIG. 5C shows a device log for storing information procured by the OHMD during at least one assembly stage, in accordance with examples of the invention.

FIG. 6A shows an example of an IMD subassembly to be assembled during a particular assembly stage, and FIGS. 6B-6D illustrate the OHMD GUI rendered by the stage algorithm to optically verify the parts and the subassembly itself, and to log information procured during the optical verification process, in accordance with examples of the invention.

### DETAILED DESCRIPTION

An Optical Head-Mounted Display (OHMD) wearable by an assembly technician and a system in which such OHMD may be used are disclosed. The OHMD is useable to optically verify parts used during an assembly stage of a subassembly of an Implantable Medical Device (IMD) for example, such as to verify that the correct parts are being used, and are properly placed within the subassembly. The OHMD further renders an OHMD Graphical User Interface to assist the technician in following the correct assembly steps, and to provide the technician feedback regarding optical verification and corrective actions that can be taken. Optical verification of parts and of the subassembly itself can occur using various optical markers on the parts and subassembly, such as bar codes, shapes, and text. The OHMD preferably also stores information relevant to such optical verification in a specific device log for the IMD for future reference. The OHMD is unobtrusive to the technician and allows the technician's hands to remain free.

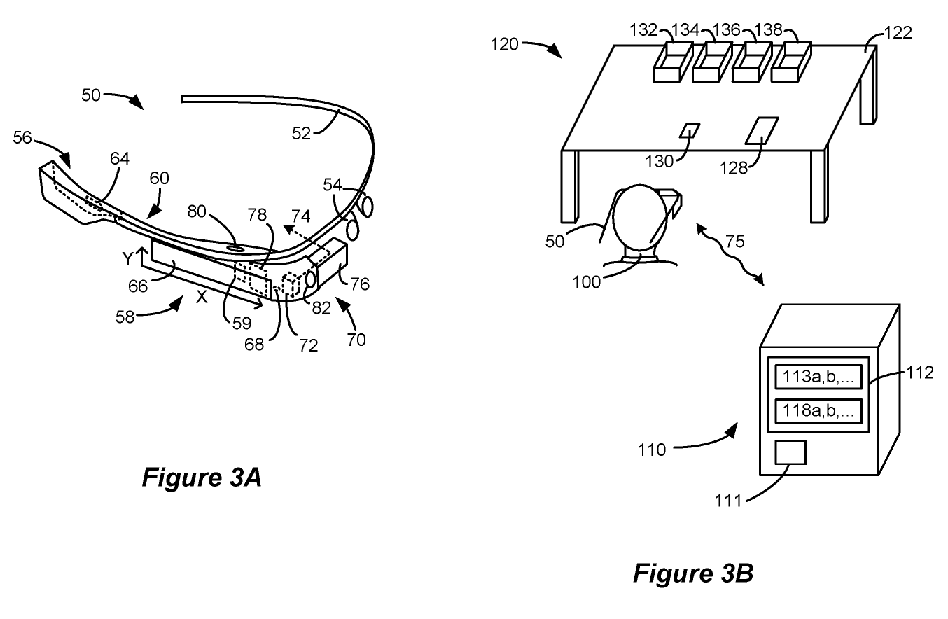

FIG. 3A shows an example of an Optical Head-Mounted Display (OHMD) 50 wearable by an IMD assembly technician 100, and FIG. 3B shows a typical assembly environment 120 in which the OHMD 50 can be used during a particular assembly stage to create an IMD subassembly 130. Assembly environment 120 includes a workstation 122, and a number of bins 132-138 containing parts that the technician 100 will use during assembly of the IMD subassembly 130. Accompanying the IMD subassembly 130 is a traveler 128, typically a document (e.g., on paper), which includes important history concerning the assembly of the IMD subassembly 130, and further includes information useful to the technician 100.

Because the IMD may be assembled in stages, it may only be partially assembled when it arrive at workstation 122, perhaps from another workstation involved in an earlier assembly stage. Likewise, the IMD subassembly 130 may only be partially (but more completely) assembled when leaves workstation 122, at which point it may be sent to another workstation involved in a later assembly stage. For example, the IMD may arrive at workstation 122 from an earlier workstation as a PCB 34 upon which were previously mounted other parts (such as the microcontroller 30, ASIC 32, etc.). The technician 100 at workstation 122 may mount other parts (such as battery 26, telemetry coil 28, etc., in bins 132-138) to the PCB 34, and may insert the now-further-completed PCB 34 into a bottom case portion 14. The IMD subassembly 130 may then be passed on to a subsequent workstation 122 along with its traveler 128 where it will undergo a subsequent assembly stage.

The OHMD 50 as shown in the example of FIG. 3A comprises a Google Glass™ OHMD, developed by Google, Inc. of Mountain View, Calif., but is not so limited, and can include other OHMDs in existence or developed in the future. OHMD 50 is configured to be wearable much like a pair of standard eyeglasses, and includes nose pads 54 and a frame 52 that also serves as the temples supported by the wearer's ears. Lenses (e.g., corrective or sunglasses lenses) may be affixed to the frame 52, but are not shown in FIG. 3A. OHMD 50 may also be worn in conjunction with a wearer's normal eyeglasses.

Plastic affixed to the frame 52 generally defines a rearward housing 56 and a forward housing 58 on the OHMD 50's right temple. Plastic also defines a pass-through portion 60, which as well as defining a space for the wearer's right ear, also provides for the passing of wires between the two housings 56 and 58. The rearward housing 56 holds a rechargeable battery (not shown). A bone-conduction audio transducer 64 in the rearward housing 56 protrudes through the plastic and presses over the right ear to permit the wearer to hear sounds provided by the OHMD's user interface, which is explained further below. OHMD 50 could also include a more-traditional audio speaker as well.

The forward housing 58 supports the OHMD 50's main electronics, such as its control circuitry 59 (e.g., a microprocessor or microcontroller), and movement sensors (not shown) including a three-axis accelerometer and a three-axis gyroscope. Also included in the outer surface of the forward housing 58 is a touch pad 66, which is sensitive to the wearer's touch across a two-dimensional expanse (X and Y) and can additionally be pressed (“tapped”) similar to a button. The underside of the forward housing 58 includes a microphone 68 for the receipt of voice input in addition to inputs receivable by the touch pad 66 and the movement sensors. The electronics of the OHMD 50 preferably includes a voice detection module for interpretation of spoken voice inputs received at microphone 68.

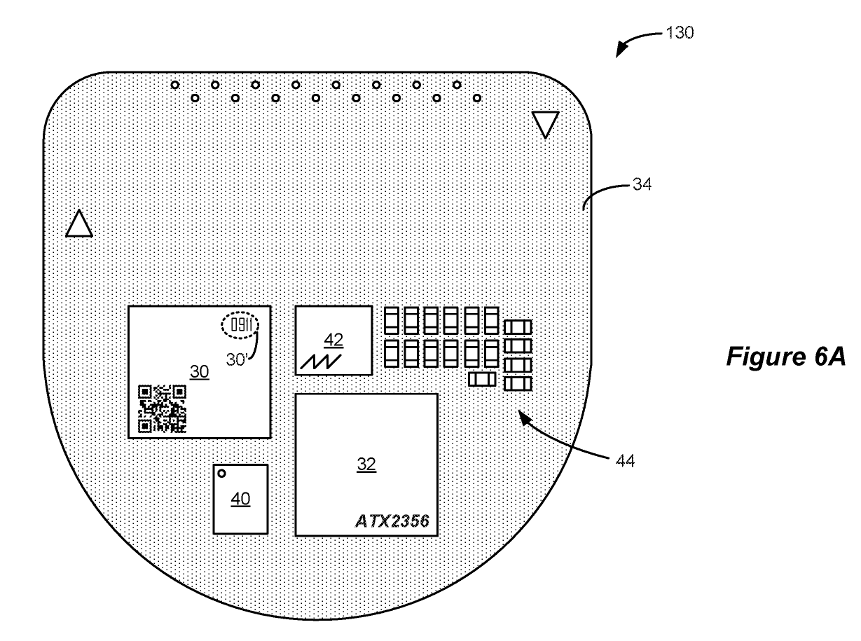

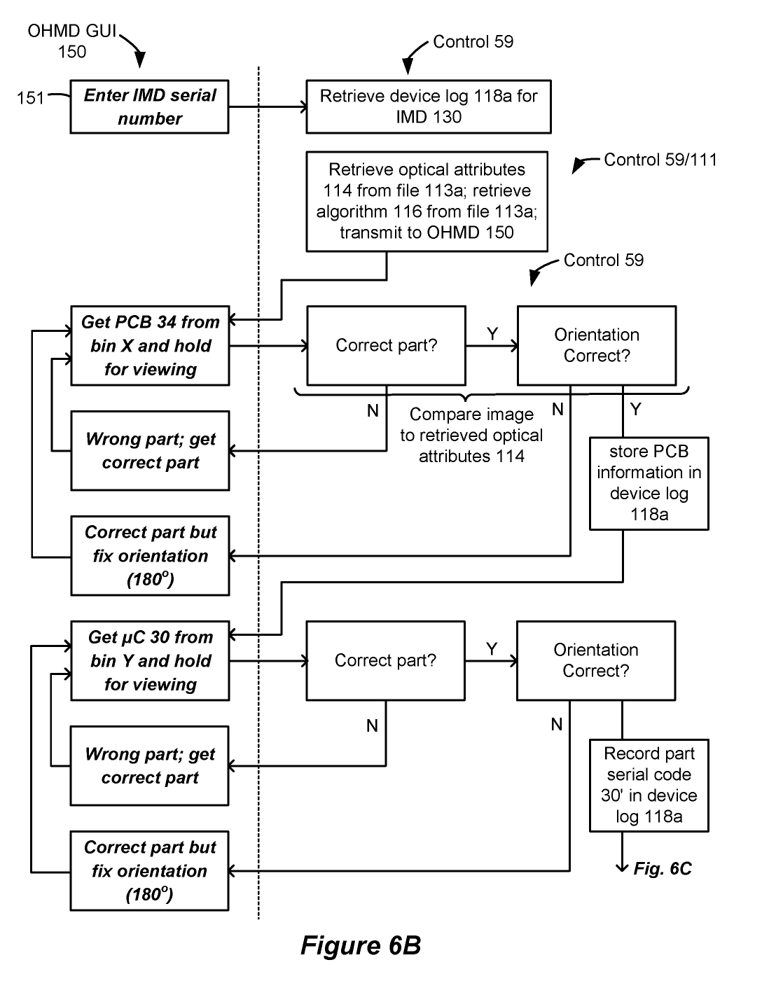

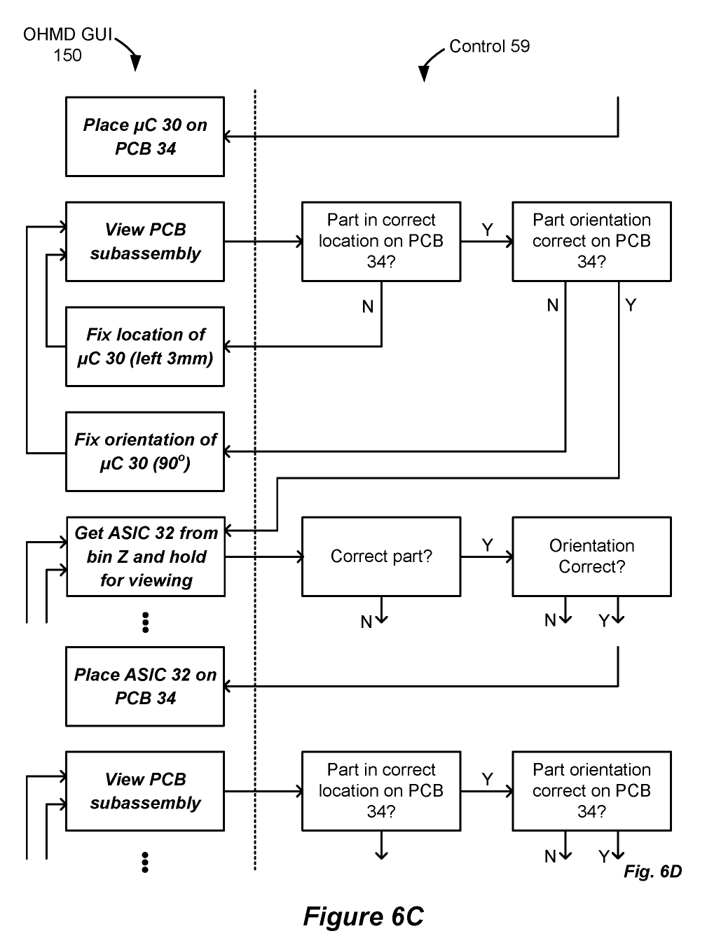

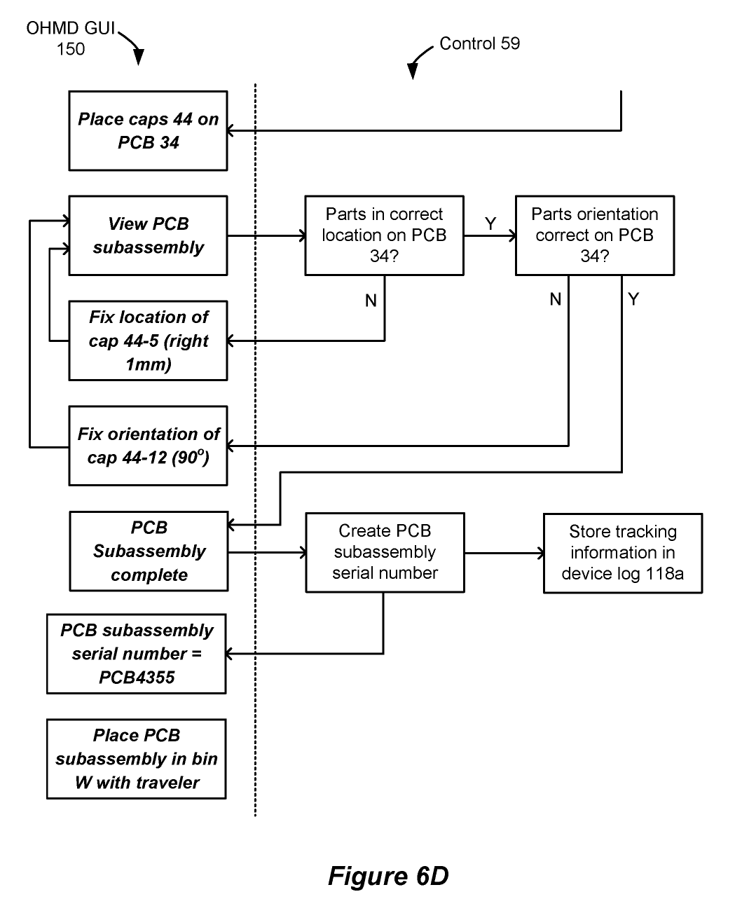

The forward housing 58 also includes a display portion 70 proximate to the wearer's right eye including an LED array 72 powered by the OHMD's control circuitry 59. Images 74 created by the LED array 72 are directed to a prism 76 containing a polarizing beam-splitter that directs the images 74 to the wearer's right eye. In this manner, the user is able to perceive the images 74 generated by the OHMD 50 and output by the display portion 70, which images 74 are provided slightly to the right of the wearer's center of vision, thus allowing the wearer to see the real world and the images on the display portion 70 simultaneously. The display portion 70 can be used to render an OHMD Graphical User Interface (GUI) 150 (FIG. 6B) to assist the technician 100 in his assembly task, as discussed further below. Forward housing 58 also includes a camera 82 facing forward for capturing images and video.

OHMD 50 may further include bi-directional short-range RF communication means, including one or more antennas 78 and telemetry circuitry (not shown) compliant with Bluetooth and Wi-Fi communication standards for example. The antenna 78 is shown located in the forward housing 58 in FIG. 3A, but could be present elsewhere in or on the OHMD 150.

As shown in FIG. 3B, the OHMD 50 can use such short-range RF communication means to communicate wirelessly with a computer system 110 via wireless link 75. Computer system 110 may comprise a stand-alone device (such as a computer, tablet, smart cell phone, server, etc.), or may comprise a number of components networked together, by the Internet or otherwise. For example, computer system 110 may include a WiFi router in communication with a server of the IMD manufacturer. Computer system 110 may include control circuitry 111 (e.g., a microprocessor), and may include memory 112. In this example, it is assumed that computer system 110 is under control of the IMD manufacturer.

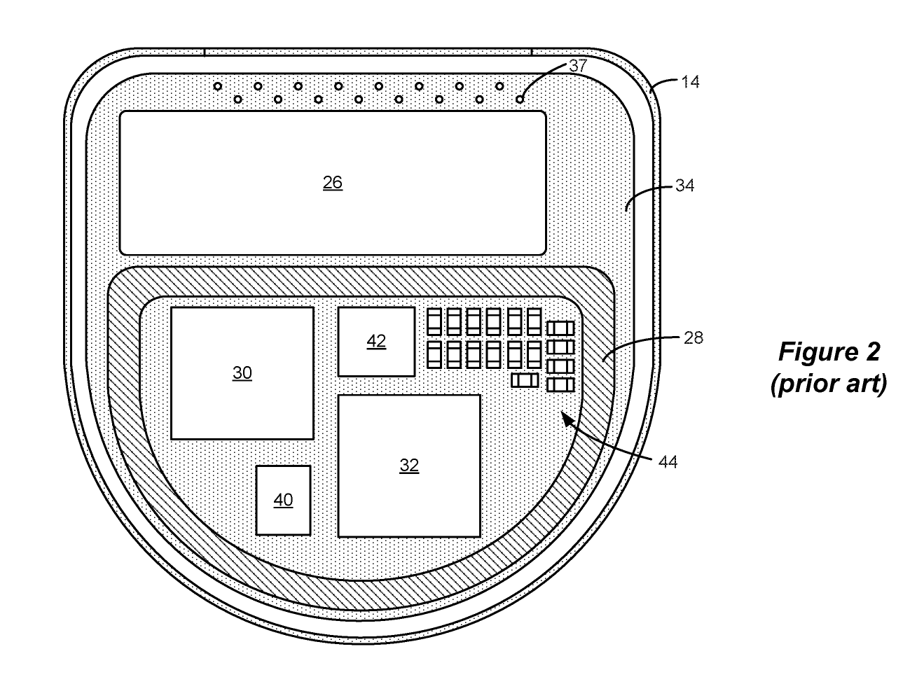

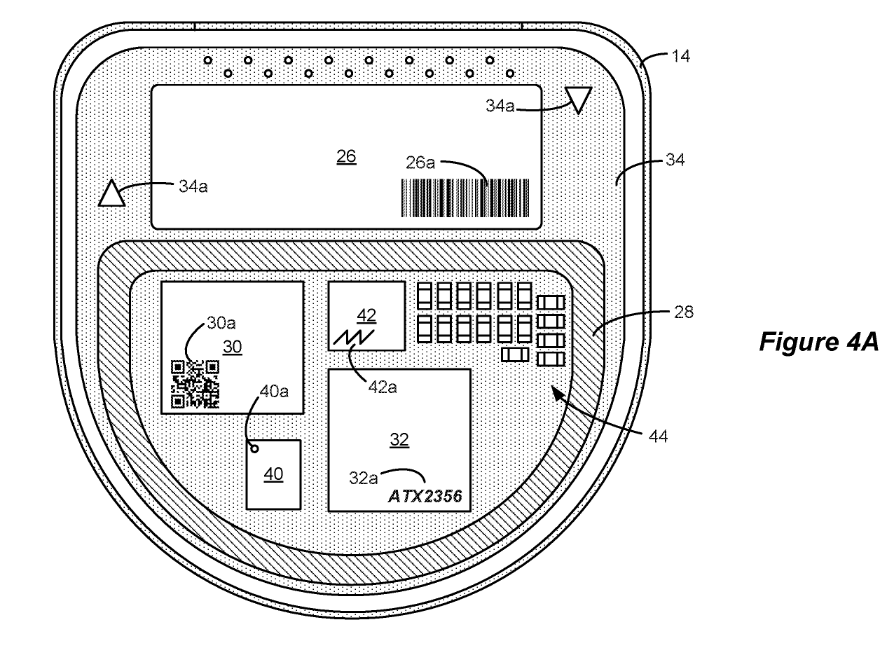

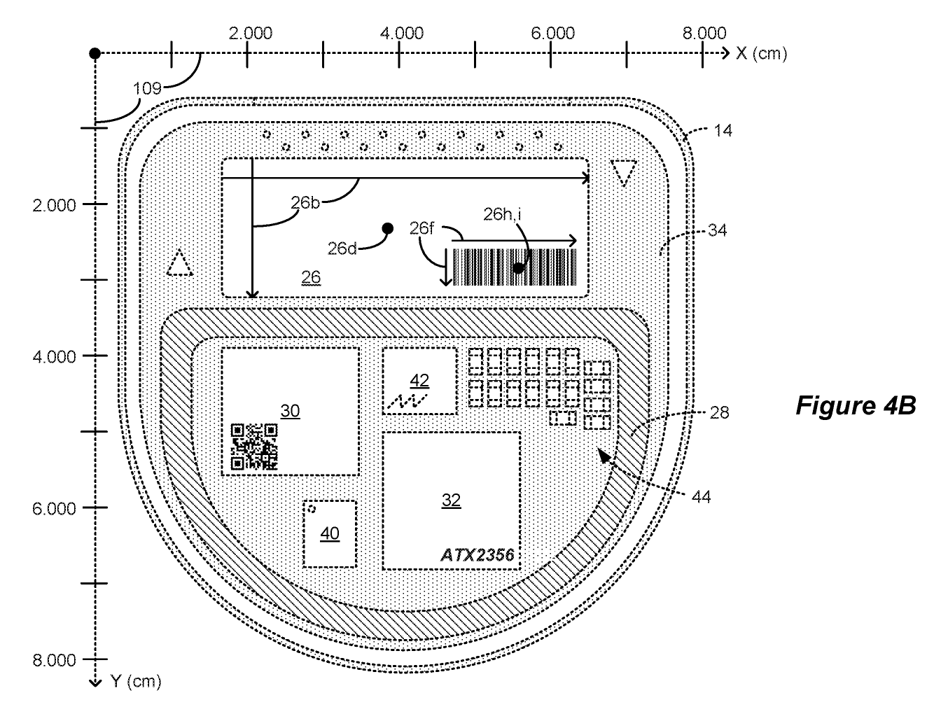

The OHMD 50's GUI can be programmed to provide assembly instructions to the technician 100, as explained further below, and further can be used to optically verify the IMD subassembly 130 under construction and the various parts added by the technician 100 at his workstation 122. Such optical verification can employ the use of various optical markers (Xa), as shown in FIG. 4A, which represents the same basic assembly stage as shown earlier with respect to FIG. 2. Such optical markers Xa and other optical attributes of the parts, and the IMD subassembly itself, can be received by the OHMD 50 at its camera 82, and can be interpreted by algorithms operable with the OHMD's control circuitry 59. Alternatively, assembly images captured using camera 82 may be provided wirelessly from the OHMD 50 to the computer system 110 with optical verification algorithms operating there instead.

Optical markers Xa may come in different types. For example, the battery 26 as illustrated includes a one-dimensional bar code 26a, interpretable by the control circuitry 59 (or computer system 110) using well known 1-D bar code identification algorithms to identify a number sequence the bar code represents. Microcontroller 30 includes a two-dimensional bar code 30a which is similarly interpretable, as is well known.

Optical markers Xa may be specifically applied to the parts by the IMD manufacturer, or may be applied by the part manufacturers themselves. Optical markers Xa need not represent data per se (as is the case with bar codes), although a given optical marker may be associated with data by the IMD manufacture, as explained further below. Optical markers Xa further need not comprise specifically applied markers, but may comprise other structures of the parts that are naturally present and hence optically verifiable, as discussed further below.

For example, ASIC 32's optical marker comprises its textual part number 32a, which may have been applied by the ASIC manufacturer. This part number 32a is interpretable by the microcontroller 59 using well-known optical character recognition (OCR) algorithms.

PCB 34 includes two optical markers in the form of a shape (e.g., a triangle 34a), which markers may be natively present on the PCB 34 or added specifically by the IMD manufacturer for optical verification purposes. As discussed further below, using of two or more optical markers on a given part or subassembly can be useful to allow the OHMD 50 to better determine orientation and scale, such as distance and angle from the OHMD's camera 82. These types of optical marker can be interpreted by the microprocessor 59 using well-known shape identification algorithms. Other parts or subassemblies can include more than one optical marker Xa, although this isn't shown for convenience. Furthermore, use of more than one optical marker 34a is not required.

Component 40's optical marker 40a comprises a “pin 1” identifier provided by the chip manufacture, which may take the form of a small circle adjacent to the first pin of the part. Component 42's optical marker 42a again comprises a unique shape. Other parts in the IMD may lack an optical marker, like the telemetry coil 28, the capacitors 44, and the bottom case portion 14, but may still be optically verified by the OHMD 50 by virtue of their shapes, sizes, or other optically-identifiable structures, as explained further below. Although not shown, the resulting IMD subassembly 130 depicted in FIG. 4A may have its own optical marker as well, and thus may be considered a part during a subsequent assembly stage.

FIG. 4B defines various optical attributes associated with each part (or each subassembly) that may be useful in interpreting images captured by the OHMD's camera 82 during an assembly stage. Such optical attributes are illustrated with respect to the battery 26 only for simplicity, but at least some of these attributes may be associated with each of the other parts. Attribute 26b defines the size of battery 26, in both X and Y dimensions. Attribute 26d defines a location of the battery 26 in the IMD subassembly 130 (e.g., relative to the PCB 34 or the bottom case portion 14), which is defined by the center of the battery 26, although it could also be defined with respect to a given edge or corner as well. Attribute 26f defines the size of the optical marker (1-D bar code) 26a itself, again in X and Y dimensions. Attribute 26h comprises the location of the optical marker 26a on the battery 26 itself, while attribute 26i comprises the location of the optical marker in the IMD subassembly 130.

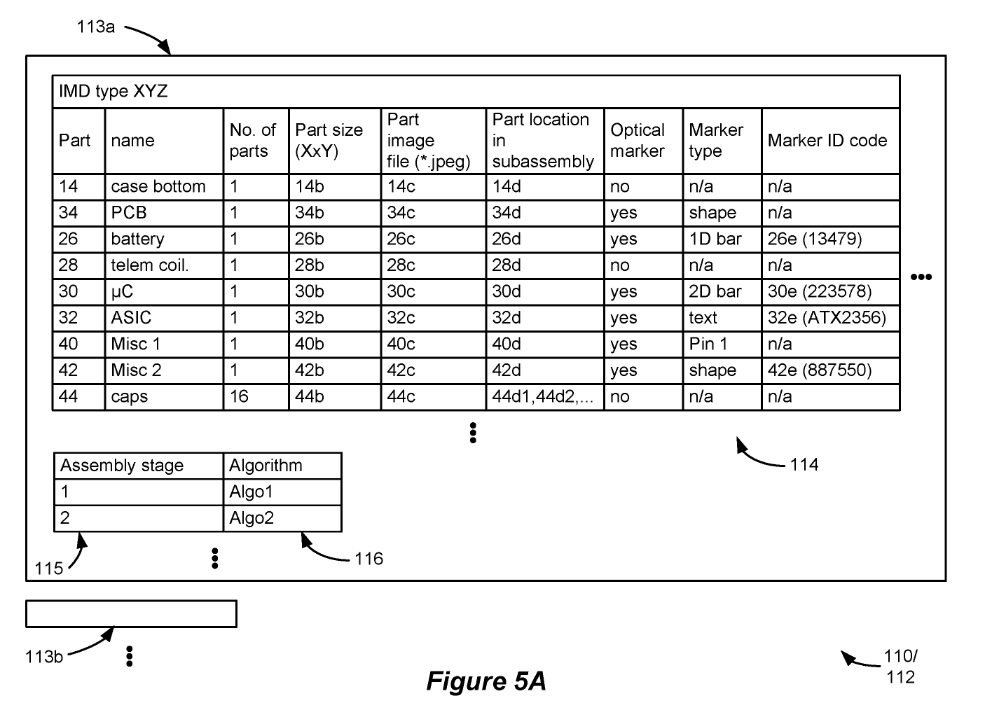

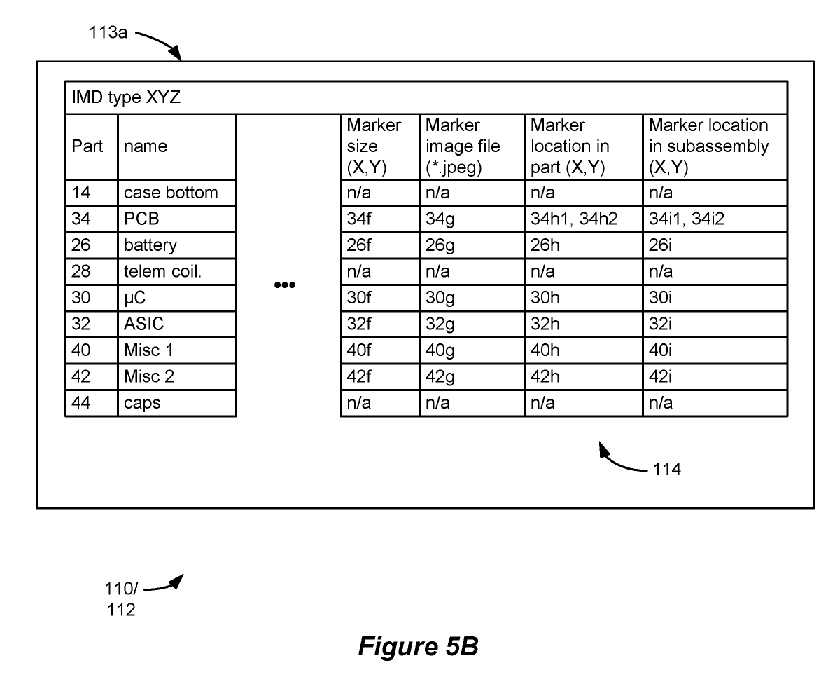

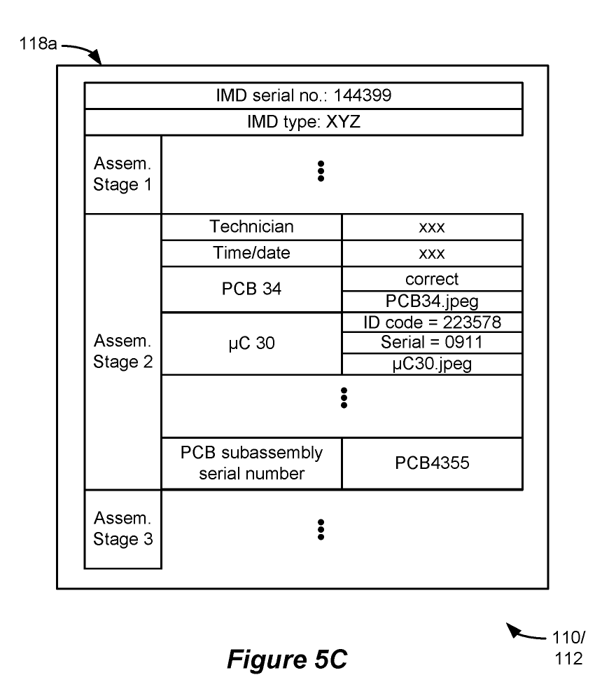

These optical attributes 114 may be defined in an assembly file 113a for a particular type of IMD (XYZ) being assembled, as shown in FIGS. 5A and 5B. File 113a includes the parts to be used in the assembly of the IMD in question, including their number and size (Xb). An image file of each part (Xc; e.g., a *.jpeg image) may also be provided, as may each part's location in the IMD subassembly 130 (Xd). Whether each part includes an optical marker (Xa) is also indicated, as well as its type (e.g., bar code, text, shape, etc.). To the extent the optical marker Xa is associated with particular data, such data (Xe) is also compiled in assembly file 113a. In this regard, the IMD manufacturer may associate data with a particular structure being used as an optical marker. For example, even though the shape of optical marker 42a (a zig-zag) does not imply any particular data, such marker has been associated with particular data (887550), which may comprise a part number for example. By contrast, optical markers 34a of the PCB 34, also shape (a triangle), are not associated with particular data, although they can still be used to optically verify the PCB 34 as explained further below.

Continuing with FIG. 5B, assembly file 113a can further include the size of the optical marker used on a part (if any; Xf), and an image file of the marker (Xg). Finally, both the location of the marker in the part (Xh) and the location of the marker in IMD subassembly 130 (Xi) may also be provided.

Although not shown, optical attributes defining locations in a subassembly—such as part or marker locations Xd and Xi—could be referenced to more than one subassembly, which could be beneficial if those parts or markers were visible during more than one assembly stage and hence visible in more than one subassembly. Thus, assembly file 113a could contain numerous values to define such relative locations.

It should be noted that assembly file 113a need not contain all of the depicted optical attributes 114; fewer or more optical attributes may be provided for each part or subassembly as relevant. File 113a is preferably stored in memory 112 of the computer system 110, and computer system 110 may store different assembly files (113b, etc.) for different IMD types assembled by the IMD manufacturer.

Referring again to FIG. 5A, assembly file 113a may include various algorithms 116 associated with each of the assembly stages 115. Each stage algorithm 116 when executed by the control circuitry 59 in the OHMD 50 will render an OHMD GUI 150 for the technician 100 involved during a particular assembly stage, and also provides feedback to the technician 100 concerning optical verification of the parts or their subassemblies, as discussed further below with respect to FIGS. 6B-6C. Stage algorithms 116 ensure that a given assembly stage occurs in the correct order of steps, and including optical verification of parts and/or the created subassembly itself. It should be noted that a single algorithm relevant to assembly of an entire IMD could also be specified in assembly file 113a, without being broken down by assembly stages. As discussed further below, each stage algorithm 116 will preferably only reference optical attributes 114 for parts that are implicated by that stage.

Computer system 110 (e.g., memory 112) may in addition to the assembly files 113 also include device logs 118, as shown in FIG. 5C, each of which includes information concerning a particular IMD under assembly. Device log 118a may include information that may also be present in the paper traveler 128 as well, such as the serial number of the IMD and the IMD type (“XYZ”). As discussed below, device log 118a can be queried by stage algorithms 116 operating in the OHMD 50 at different assembly stages, and may have information added to it as well and as discussed subsequently. As such, device log 118a may contain information concerning the last assembly stage encountered by the IMD, which may be useful as information in the log 118a may be automatically populated for the benefit of technician 100 in the OHMD GUI 150 in a subsequent assembly stage. Each IMD under assembly preferably has its own device log 118 (e.g., 118a, 118b, etc.).

The IMD during its assembly is preferably eventually marked with an IMD serial number. This allows an IMD to be correlated with its device log 118 as stored in computer system 110 even after the IMD enters the field (e.g., is implanted into a patient). As discussed further below, the ability to review a particular IMD's device log 118 can provide beneficial information to the IMD manufacturer. An IMD can be marked with its serial number in many ways, including manners determinable via imaging (e.g. Xray) even after implantation. For example, the IMD during assembly can have its IMD type and/or its IMD serial number engraved (e.g., by laser inscription) on either the top 13 or bottom 14 portions of the case 12, or elsewhere on the IMD 130. Such information may also be affixed to the IMD 130 via an adhesive.

FIG. 6A illustrates an IMD subassembly 130 that a technician 100 is involved in creating during a particular assembly stage, and FIGS. 6B-6D show an example of the OHMD 150 that a stage algorithm 116 in the OHMD 50 renders to assist the technician 100. Essentially, this assembly stage involves mounting various electrical parts to the PCB 34 during the creation of a PCB subassembly 130. While these particular steps may be most logically automated by equipment in an actual manufacturing example, assuming the use of a human technician 100 to accomplish this assembly stage is nonetheless illustrative.

Referring to FIG. 6B, the OHMD GUI 150 presents assembly steps and feedback to the technician 100 wearing the OHMD 50 as a series of visible cards 151 provided by the OHMD's display portion 70, such as is explained in U.S. Patent Application Publication 2015/0360038. An initial card 151 may prompt the technician 100 to enter the IMD serial number. Such entry may be made verbally by the technician, who may speak for example “IMD Serial 144399,” which voice command is interpreted by voice recognition software associated with control circuitry 59 in the OHMD 50. The technician 100 may read the IMD serial number from the traveler 128 or from the subassembly itself is it is marked, although other means of providing the IMD serial number to the OHMD 50 are possible. For example, if the IMD serial number is on the subassembly, the serial number may be procured automatically by the OHMD 50 using optical character recognition, or the user may select the IMD serial number from a list provided on a card 151.

Once the IMD serial number is entered into the OHMD GUI 150, it is wirelessly transmitted to the computer system 110, which pulls the appropriate device log 118a (FIG. 5C) for that serial number. Because the device log 118a preferably contains the IMD type (XYZ), the appropriate assembly file 113a can be pulled using the device log 118a. Device log 118a may also contain information of the last assembly stage, and thus it may be understood which next assembly stage the technician 100 is currently engaged in, thus allowing the appropriate stage algorithm 116 to also be pulled from assembly file 113a. Alternatively, the user can enter the IMD type and the current assembly stage into the OHMD GUI 150. In any event, the OHMD 50 will wirelessly transmit the necessary information from the OHMD 50 to the computer system 110 to allow the appropriate optical attributes 114 and the appropriate stage algorithm 116 from the correct assembly file 113a to be transmitted to the OHMD 50.

Once such information is received at the OHMD 50 from the computer system 110, the control circuitry 59 in the OHMD 50 can execute the retrieved stage algorithm 116, which will instruct the technician 100 how to proceed in the creation of the subassembly. In the example shown, the OHMD 150 first instructs the technician 100 to get a PCB 34, which may be blank or partially assembled. The OHMD 150 may further instruct the technician which of bins 132-138 the PCB 34 is in, if such information is in included in the assembly file 113a (not shown in FIGS. 5A-5B).

The OHMD 150 further instructs the technician to hold the PCB 34 in a position for viewing and so that the OHMD 50 may take an image with the camera 82. This can involve the technician holding the PCB 34 in front of the OHMD's camera 82 at a comfortable distance, as if the technician were reading a book for example. At this point, the stage algorithm 116 can take an image of the PCB 34, and optically analyze the image by comparing it with one or more of the retrieved optical attributes 114 to determine if PCB 34 is the correct part, and further if its orientation is correct (e.g., right-side up), and instruct the technician 100 if there is a problem with either. For example, and as FIG. 6B shows, the OHMD GUI 150 can instruct the technician that the part's orientation is 180 degrees off (i.e., upside down), thus allowing the technician to fix this problem before proceeding to add additional parts to the PCB subassembly 130.

Optical analysis in the OHMD 50 is assisted by the previously-procured optical attributes 114 for the IMD in question. For example, the OHMD 50 can compare the image of the PCB 34 to the part image (34c) optical attribute 114 to see if they match. The OHMD 50 can also assess the optical markers 34a on the PCB 34, and compare them to marker image (34g) to see they match. Upon detecting the optical markers 34a, the OHMD 50 can further determine their marker ID code(s) 34(e) (if any), and may check to see that the markers 34a are in the expected location in the part (34h1, 34h2), or that the marker sizes (34i) are correct, perhaps with respect to the part size 34b. Detecting the location of the marker relative to the PCB 34 (34h) is particularly useful in determining orientation—e.g., to determine if the part is accidentally being held upside down. Image files (34c, 34g) can also be useful in this regard, particularly if the part or marker has a unique shape that is not radially symmetric. All or some of these optical analysis steps can take place to add redundancy in verifying PCB 34 as correct and properly oriented.

It should be understood that optical analysis will depend on the distance and angle with which parts are held relative to the OHMD's camera 82. In this regard, it can be useful to the algorithm 116 to normalize the images it receives to map them to particular X-Y coordinates 109 (FIG. 4B). For example, if the edges of the PCB 34 do not appear perpendicular, the algorithm 116 may understand that the PCB 34 is being held at an angle and can make proper adjustments accordingly. Furthermore, use of two or more optical markers 34a can help in this regard, as the relative size and position of these markers as determined by the OHMD 50 determined can be used to normalize the image. Note that optical markers 34a can also be used during subsequent assembly steps as well to determine whether added parts are placed in the subassembly with the correct position and orientation.

After optically verifying the PCB 34, the algorithm 116 can then store information gleaned concerning the PCB 34 in device log 118a, preferably as associated with the particular assembly stage. As shown in FIG. 5C, this can include for example: the name of the technician 100; the time and date; the ID code (34e) associated with optical marker(s) 34a (if any) or an indication that PCB 34 was correctly optically verified by other means; and the image of the PCB 34 used for optical analysis. Other variables may be stored as well, such as measured PCB size, etc. Such device log information may be temporarily stored in the OHMD 50 for later transmission to the device log 118a in the computer system 110, or transmitted as soon as it is acquired.

After storage in the device log 118a, the stage algorithm 116 can now instruct the technician 100 to retrieve a next part in the PCB subassembly 130 under construction (i.e., the microcontroller 30), and hold for viewing to again determine if this part is correct and properly oriented, again by comparing the captured image with one or more of the retrieved optical attributes 114. In this instance, the microcontroller 30 has a 2-D bar code as its optical marker 30a, and so the ID code associated with this marker (30e) can be used for part verification (and stored in log 118a as well). Other information may be optically identified and stored as well.

For example, as shown in FIG. 6A, the microcontroller 30 has a textual serial code 30′ (0911) applied by its manufacturer, which can be recovered via OCR at the OHMD 50, and stored in the log 118a. This is particularly useful as it can assist in quality and reliability analysis later on. For example, if a subset of patients with IMD type XYZ are experiencing problems, consultation of the various device logs 118 for those patients may draw a correlation to microcontrollers 30 having particular serial codes. Other textual information printed on various parts aside from serial codes can be OCRed and stored in various device logs 118 as well.

Next, and referring to FIG. 6C, the OHMD 150 can instruct the technician to place the properly-oriented microcontroller 30 on the previously-verified PCB 34 and to view it as it viewed the individual parts for further optical assessment of the growing PCB subassembly 130. Once so placed, the position and orientation of the microcontroller 30 within the PCB 34 can be checked. Optical attributes 114 that set the location of the part or marker in the subassembly (such as 30d and 30i) are especially helpful in this regard, as the PCB 34 is also imaged along with the mounted microcontroller 30 to provide a frame of reference. If the PCB 34 has two optical markers 34a as shown, determining proper orientation and placement of the microcontroller 30 is also facilitated, as the microcontroller 30 can be optically compared to both of these markers as a point of reference. Again, the technician 100 can be notified of optical verification problems and corrective actions that can be taken, such as to move or re-orient the microcontroller 30 on the PCB 34.

This process can continue to add additional parts to the PCB subassembly 130, such as the ASIC 32, etc. That is, each newly-added part can itself be optically verified and logged (118a), and additionally optically verified and logged upon being added to the subassembly. It should be noted however that it is not strictly necessary that parts be both independently optically verified and optically verified once added to the subassembly; only one or the other can be assessed.

FIG. 6D illustrates last parts being added to the subassembly, namely capacitors 44, which lack an optical marker. Optical verification of such parts may still occur by a comparison to their image files (e.g., 44c) in the procured assembly file 113a. As shown in FIG. 6D, capacitors 44 are only optical verified once they have been added to the PCB subassembly 130, rather than individually beforehand. This makes sense given the relative small size of such parts, and their lack of individual optical markers. Nonetheless, once mounted, the stage algorithm 116 can optically verify such parts (e.g., relative to the part size 44b optical attribute, as well as the various part locations (44d1 and 44d2)) on the PCB subassembly 130. As there are several capacitors 44, the algorithm 116 may optically verify and provide feedback to the technician 100 regarding each capacitor separately, as FIG. 6D illustrates.

After the subassembly is complete and all parts have been placed, the algorithm 116 can inform the technician 100 of this fact. If necessary, a subassembly serial number can be assigned (if not previously assigned or known) by the algorithm 116 and provided to the technician 100 by the OHMD GUI 150, and ultimately stored in the device log 118a. Although not illustrated, the OHMD 150 may also instruct the technician 100 to mark the subassembly serial number on the traveler 128 and possibly also on the subassembly itself. The OHMD 150 may also instruct the technician to place the subassembly in a particular bin at his workstation 122 so that it can be transferred to a subsequent workstation.

Once subassembly 130 is completed, it may be considered as a part and therefore subsequent optically verified at different assembly stages as it is combined with other parts. For example, PCB subassembly 130 in a later assembly stage may be placed in the bottom case portion 14, and have feedthrough pins soldered to contact holes 37 in the PCB 34 to create a bottom case subassembly. During such later stage, another technician 100 can likewise wear the OHMD 50; use the PCB subassembly serial number to retrieve optical attributes 114 and a stage algorithm 116 from assembly file 113a; optically verify the PCB subassembly; optically verify a bottom case portion 14; place the PCB subassembly in the bottom case portion 14; optically verify that subassembly; solder the feedthrough pins; verify the correct position and orientation of the feedthrough pins in the new bottom case subassembly, etc.

While creation of a subassembly has been illustrated, it should be understood that the disclosed technique can also apply to a full assembly of an IMB. “Subassembly” should thus be understood as including both an IMB in its fully- or partially-assembled states.

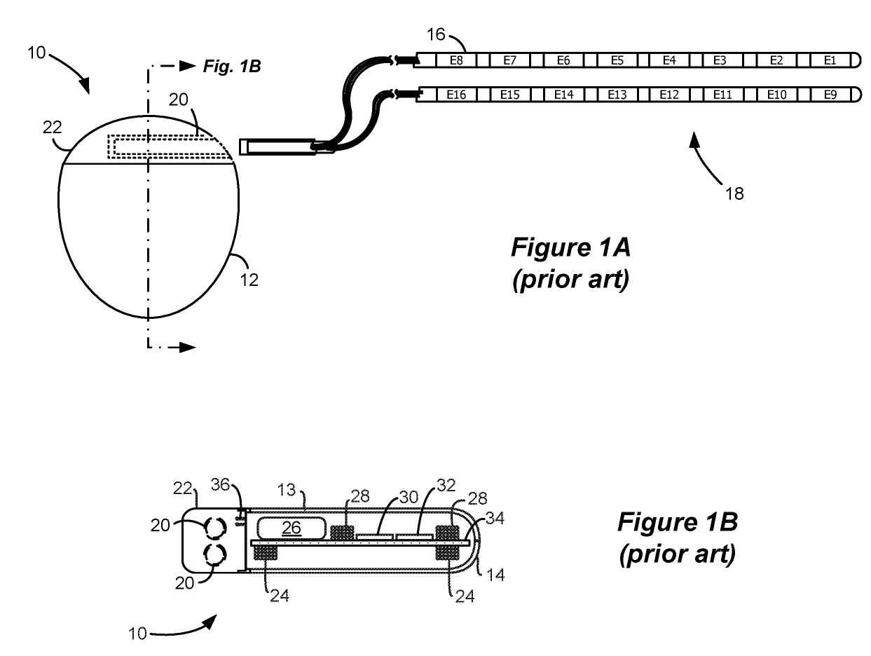

Further, while the disclosed system was inspired to ease and render more reliable the assembly of implantable medical devices, it should be noted that the disclosed system and its use of OHMD 50 is not limited to the assembly of such products. For example, the OHMD 50 and system may be used during the assembly of other medical devices, such as implantable leads (e.g., 18; FIG. 1), or other external devices used to communicate with an implantable medical device, such as external controllers or external chargers for such devices. In fact, the OHMD 150 and system may be used to facilitate the assembly of any device, including those without medical applications.

Control circuitry 59 operable in the OHMD 50 can comprise for example Part Number MSP430, manufactured by Texas Instruments, which is described in data sheets at http://www.ti.com/lsds/ti/microcontroller/16-bit_msp430/overview.page? DCMP=MCU_other& HQS=msp430, which is incorporated herein by reference. However, other types of control circuitry may be used as well, such as microprocessors, FPGAs, DSPs, or combinations of these, etc.

Although particular embodiments have been shown and described, it should be understood that the above discussion is not intended to limit the present invention to these embodiments. It will be obvious to those skilled in the art that various changes and modifications may be made without departing from the spirit and scope of the present invention. Thus, the present invention is intended to cover alternatives, modifications, and equivalents that may fall within the spirit and scope of the present invention as defined by the claims.

What is claimed is:

1. A method for assembling a medical device, comprising:
providing a Graphical User Interface (GUI) at a display portion of an Optical Head-Mounted Display (OHMD) configured to be worn on the head of an assembly technician, wherein the OHMD further comprises a camera and control circuitry;
providing from the GUI at least one assembly step instruction regarding at least one part to be added to a subassembly of the medical device during an assembly stage;
receiving an image of each at least one part at the camera in response to each instruction; and
using the control circuitry to optically verify each at least one part as correct using each image.

2. The method of claim 1, wherein the control circuitry is used to optically verify each at least one part before being added to the subassembly.

3. The method of claim 2, wherein if a part is not optically verified as correct, providing a notification to the assembly technician via the GUI.

4. The method of claim 1, wherein the control circuitry is further used to optically verify an orientation of each at least one part using each image.

5. The method of claim 4, wherein if a part's orientation is not optically verified, providing a notification to the assembly technician via the GUI.

6. The method of claim 1, wherein the control circuitry is used to optically verify each at least one part after it is added to the subassembly.

7. The method of claim 6, wherein the control circuitry is further used to optically verify a location or orientation of at least one part in the subassembly.

8. The method of claim 1, wherein the control circuitry is used to optically verify each at least one part using an optical marker on each at least one part.

9. The method of claim 1, wherein the control circuitry is used to optically verify each at least one part using a size or shape of each at least one part.

10. The method of claim 1, wherein at least one part comprises an optical marker.

11. The method of claim 10, wherein the control circuitry is used to optically verify each at least one part by verifying data associated with the optical marker.

12. The method of claim 10, wherein the control circuitry is used to optically verify each at least one part by verifying a shape or size of the optical marker.

13. The method of claim 10, wherein the control circuitry is used to optically verify each at least one part by recognizing text of the optical marker.

14. The method of claim 1, further comprising retrieving at least one optical attribute associated with each at least one part, and wherein the control circuitry is used to optically verify each at least one part by comparing the image to the at least one optical attribute.

15. The method of claim 14, wherein the OHMD comprises an antenna, and further comprising receiving the at least one optical attribute wirelessly at the antenna.

16. The method of claim 1, wherein the at least one assembly step instruction is provided in accordance with a stage algorithm.

17. The method of claim 16, wherein the stage algorithm provides the at least one assembly step instruction in order by which the at least one part is to be added to the subassembly during the assembly stage.

18. The method of claim 1, further comprising storing information associated with optical verifying each at least one part in a log file for the medical device.

19. The method of claim 18, wherein the OHMD comprises an antenna, and further comprising transmitting the log file for the medical device to a computer system.

20. A non-transitory machine-readable medium upon which are stored instructions for assembling a medical device executable by an optical head-mounted display (OHMD) configured to be worn on the head of an assembly technician, wherein the instructions when executed on the OHMD are configured to:
providing a Graphical User Interface (GUI) at a display portion of the OHMD, wherein the OHMD further comprises a camera and control circuitry;
providing from the GUI at least one assembly step instruction regarding at least one part to be added to a subassembly of the medical device during an assembly stage;
receiving an image of each at least one part at the camera in response to each instruction; and
using the control circuitry to optically verify each at least one part as correct using each image.
